(19) United States
(12) Patent Application Publication
(10) Pub. No.: US 2025/0381747 A1
(43) Pub. Date: Dec. 18, 2025

(54) MOLDING DIE AND PRODUCING METHOD OF ETPU SLIPPERS

(71) Applicants: Quanzhou Wanjiaxin New Material Technology Co., Ltd., Quanzhou (CN); CAS VALUE (FUJIAN) TECHNOLOGY CO., LTD., Quanzhou (CN); Jinjiang Boshite New Material Technology Co., Ltd., Quanzhou (CN)

(72) Inventors: Fuzhi LIN, Quanzhou (CN); Yaosheng ZHU, Quanzhou (CN); Zhicai LIN, Quanzhou (CN)

(21) Appl. No.: 18/820,415

(22) Filed: Aug. 30, 2024

(30) Foreign Application Priority Data
Jun. 14, 2024 (CN) 202410770489.4

(51) Int. Cl. B29D 35/02; B29C 44/02; B29C 44/34; B29C 44/56; B29C 44/58; B29C 71/02; B29K 75/00; B29K 105/00; B29K 105/04; B29L 31/50

(52) U.S. Cl. CPC B29D 35/02; B29C 44/02; B29C 44/3426; B29C 44/3461; B29C 44/56; B29C 44/585; B29C 71/02; B29K 2075/00; B29K 2105/04; B29K 2105/251; B29L 2031/50

(57) ABSTRACT

The present application provides a molding die and processing method of ETPU slippers; the die includes a movable die module and a fixed die module, wherein the movable die module includes a movable die base, a male die fixed on the movable die base and a movable inner support movably arranged in the male die; a first die cavity is formed in a side surface of the male die, a movement channel is formed in an inner bottom wall of the first die cavity, and the movable inner support is movably mounted in the movement channel; the fixed die module includes a fixed die base and a die frame fixed on the fixed die base, and a second die cavity is formed in a side surface of the die frame.

### CROSS-REFERENCE TO RELATED APPLICATION

The present application claims the priority benefits of China patent application No. 202410770489.4, filed on Jun. 14, 2024. The entirety of China patent application No. 202410770489.4 is hereby incorporated by reference herein and made a part of this specification.

### FIELD OF THE INVENTION

The present application relates to the field of expanded thermoplastic polyurethane (ETPU) slipper manufacturing technologies, and, in particular, to a molding die and producing method of ETPU slippers.

### BACKGROUND OF THE INVENTION

As a kind of shoes, slippers are mainly worn by a person indoors. Various slippers exist and may include flip-flops, half pack slippers, mesh slippers, hole slippers, or the like, according to shapes thereof.

ETPU is a kind of polyurethane thermoplastic foamed particles which are oval non-crosslinked foamed particles containing micro closed bubbles formed by carrying out pressure and heat treatment on TPU particles, having a shape of popcorn. ETPU has better resilience, deformation recovery, and wear resistance than other common sole materials, such as EVA.

Existing ETPU is usually used for manufacturing soles, and the manufactured soles are bonded with uppers to obtain complete slippers; obviously, the processing process has a low efficiency and is not beneficial to mass production of the slippers.

Currently, slippers completely made of ETPU is not available on the market, but it can be known that when the soles and the uppers are made of same materials, the whole slippers can be directly made using a single foaming molding process.

Therefore, a way of molding the ETPU slippers in a die using single foaming and releasing the ETPU slippers from the die after molding becomes a problem required to be solved.

### SUMMARY

Based on this, the present application provides a molding die and producing method of ETPU slippers, in which the whole ETPU slippers can be molded using single foaming and conveniently released after molded, so as to facilitate mass production of the ETPU slippers.

In a first aspect, the present application provides a molding die of ETPU slippers, which has the following technical solution.

A molding die of ETPU slippers includes a movable die module and a fixed die module, wherein the movable die module includes a movable die base, a male die fixed on the movable die base and a movable inner support movably arranged in the male die; a first die cavity is formed in a side surface of the male die, a movement channel is formed in an inner bottom wall of the first die cavity, and the movable inner support is movably mounted in the movement channel;

the fixed die module includes a fixed die base and a die frame fixed on the fixed die base, and a second die cavity matched with the male die in shape is formed in a side surface of the die frame; in an assembly state, the movable inner support moves towards an inner side of the male die to a limit position, and a first molding space for molding an upper surface is formed between the movable inner support and the male die; the male die enters the second die cavity in a matched mode, and a second molding space for molding a sole is formed between the movable inner support and the die frame.

By adopting the above technical solution, by mutually assembling the movable die module and the fixed die module, the movable inner support can move to the limit position along the movement channel towards the inner side of the first die cavity of the male die, and meanwhile, the male die enters the second die cavity in the matched mode; the first molding space can be formed between the movable inner support and an inner wall of the first die cavity of the male die, the second molding space can be formed between the movable inner support and an inner wall of the second die cavity of the die frame, the first molding space and the second molding space are communicated with each other, and after ETPU particles are subsequently injected into the die cavity, the ETPU slippers can be molded using single foaming by steam pressurization and heating.

In addition, after the slippers are molded by foaming, the movable die module is separated from the fixed die module, and a distance between the movable inner support and the inner wall of the first die cavity is increased by forcing the movable inner support to move outwards along the movement channel, thus facilitating the smooth release of the slippers, and facilitating an improvement of a production efficiency of the slippers to facilitate the mass production of the ETPU slippers.

Optionally, the movable inner support includes a movable portion and an inner support portion which are connected, and a shape of the inner support portion is matched with a shape of a foot; a shape of the movable portion is matched with a shape of the movement channel, the movable portion is movably inserted into the movement channel, and in the separated state, a rotation allowance is reserved between the movable portion and the movement channel after the movable inner support moves away from the first die cavity.

By adopting the above technical solution, the inner support portion is provided so that the molding spaces for molding the slippers can be formed between the inner support portion and the male die and between the inner support portion and the die frame during assembly, so as to facilitate integral foaming molding of the ETPU slippers; due to the arrangement of the movable portion, the movable inner support moves smoothly inside the movement channel, and after the movable inner support moves away from the first die cavity, the rotation allowance can be reserved between the movable portion and the movement channel, and the movable inner support can swing up and down by forcing the movable portion to rotate, such that an operator can take out the molded ETPU slippers smoothly, thus improving convenience of the release of the slippers.

Optionally, a guide seat is movably inserted in a side surface of the movable die base close to the fixed die base, the guide seat is constantly exposed out of the movable die base, and the guide seat is fixedly connected with the movable portion; a guide post is fixed on a side surface of the guide seat close to the fixed die base, and a hard rubber sleeve is sleeved on an outer circumferential side of the guide post; the die frame is provided with a guide groove, and in the closed state, the guide post is inserted into the guide groove in a matched mode, and the hard rubber sleeve is in interference fit with the guide groove.

By adopting the above technical solution, by arranging the guide seat to be fixedly connected with the movable portion, when the movable die module and the fixed die module are assembled to each other, the guide seat can abut against the fixed die base, move towards an inner side of the movable die base under a reacting force of the fixed die base, and then drive the movable portion to move towards the inner wall of the first die cavity, and finally, the guide post of the guide seat is inserted into the guide groove of the die frame in the matched mode, and the movable portion can move inwards to the limit position to facilitate the integral foaming molding of the ETPU slippers.

In addition, by arranging the hard rubber sleeve to be in interference fit with the guide groove, the guide seat can be driven away from the movable die base by a distance using a friction force between the hard rubber sleeve and an inner wall of the guide groove in the separation process, such that the movable inner support automatically moves away from the inner wall of the first die cavity by a distance, which is more favorable for rapid release of the ETPU slippers after foaming molding.

Optionally, a steam chamber for conveying steam is formed in the movable die base, the movement channel penetrates through the male die and is in communication with the steam chamber, and the movable inner support and the die frame can be kept directly opposite by a steam pressure in the opened state; the movable inner support is of a hollow structure, an opening communicated with the steam chamber is formed in a side surface of the movable portion away from the inner support portion, and a plurality of steam micropores are distributed in a surface of the inner support portion.

By adopting the above technical solution, the high-temperature steam is conveyed to an inner side of the movable inner support by the steam chamber in the closed state, and after entering the inner side of the movable inner support under the action of the pressure, the steam can enter a region between the male die and the die frame through each steam micropore, such that the ETPU particles are foamed again to obtain the whole ETPU slippers. In the opened state, the pressure of the steam in the steam chamber acts on the guide seat, such that the guide seat and the movable inner support can be adjusted to a position directly opposite to the fixed die base, so as to facilitate smooth performing of next assembly and reduce possibility of device failure.

Optionally, a plurality of first molding parts are arranged at a side edge of the movable inner support and configured to mold holes at an edge of an upper; a plurality of second molding parts are arranged at an inner bottom wall of the first die cavity, a plurality of third molding parts are arranged on a side surface of the movable inner support, and in the closed state, the second molding parts correspondingly abut against the third molding parts to form the holes in the upper surface.

By adopting the above technical solution, the first molding parts can automatically form the holes at the edges of the slippers after the ETPU particles are foamed, and the second molding parts and the third molding parts can automatically form the holes in the surfaces of the slippers after the ETPU particles are foamed, such that the ETPU slippers can keep good air permeability, and air holes are not required to be additionally processed subsequently, thus further improving the production efficiency of the ETPU slippers.

Optionally, the movable inner support is of a hollow structure, a plurality of movement grooves are formed in a side edge of the movable inner support, the first molding parts are correspondingly and slidably inserted into the movement grooves, and an elastic mechanism is arranged between the first molding parts and the movable inner support;

a retaining part is further provided on the inner side of the movable inner support, the retaining part is slidably connected to the guide seat, and in the opened state, the retaining part and the first molding part are staggered, and the elastic mechanism forces the first molding part to move towards the inner side of the movable inner support; in the closed state, the retaining part can abut against each first molding part to force the first molding part to move outwards to a limit position.

By adopting the above technical solution, the retaining part is arranged, and the retaining part can abut against each first molding part in the closed state, such that the first molding parts move outwards to the limit positions to facilitate smooth molding of the holes in the edges of the slippers; in the opened state, the retaining part can stay at a position staggered with the first molding part, and at this point, the first molding part can automatically retract into the inner side of the movable inner support under an elastic action of the elastic mechanism, thus improving convenience of the release of the ETPU slippers.

Optionally, a sliding groove is formed in a side surface of the guide seat, an extending direction of the sliding groove is the same as a moving direction of the movable inner support, the retaining part is fixedly connected with a sliding post, and the sliding post is slidably connected to the sliding groove; a first blocking seat and a second blocking seat are fixedly erected on the inner side of the movable die base, and the second blocking seat is located on a side of the first blocking seat away from the retaining part; the retaining part is fixedly connected with a limiting post, the limiting post is partially located between the first blocking seat and the second blocking seat, and in the opened state, the limiting post abuts against the first blocking seat, and the retaining part is staggered with each first molding part; in the closed state, the limiting post abuts against the second blocking seat and the sliding post abuts against a side end surface of the sliding groove close to the fixed die base.

By adopting the above technical solution, by slidably connecting the sliding post to the sliding groove, the retaining part can move along the moving direction of the movable inner support; when the movable die module is assembled to the fixed die module, the side end surface of the sliding groove close to the fixed die base can abut against the sliding post and force the sliding post to move inwards, and finally, the limiting post can abut against the second blocking seat, and the retaining part can be kept fixed by limiting of the side end surface of the sliding groove close to the fixed die base and limiting of the second blocking seat; at this point, the retaining part can abut against the first molding parts to facilitate the smooth molding of the holes in the edges of the slippers. After the slippers are molded by foaming, the movable die module is separated from the fixed die module, the movable inner support can still move outwards after the sliding post abuts against the first blocking seat, and finally, the retaining part can be in a state of being staggered with the first molding part, such that the elastic mechanism can naturally drive the first molding part to automatically retract into the inner side of the movable inner support, so as to release the slippers.

Optionally, the elastic mechanism includes a base plate fixedly erected on an inner side surface of the movable inner support and a plurality of insertion posts fixed on an outer edge of the base plate, the first molding part is provided with an insertion hole, and the insertion post is inserted into the insertion hole in a matched mode; an end of the insertion post away from the base plate is provided with a disengagement-preventing portion, a spring is provided between the disengagement-preventing portion and the first molding part, and the spring is configured to force the first molding part to move towards the base plate.

By adopting the above technical solution, in the opened state, the retaining part and the first molding part are staggered, the first molding part can be forced to move towards the base plate by an elastic force generated by the spring and acting on the first molding part, and then, the first molding part can automatically retract into the inner side of the movable inner support.

Optionally, a plurality of sole patterns are arranged on an inner bottom wall of the second die cavity, a surface of the sole pattern is provided with a plurality of raised pillars, and the raised pillars are configured to position sole rubber sheets.

By adopting the above technical solution, the raised pillar is provided to position the sole rubber sheet, the ETPU particles are injected between the male die and the die frame after the assembly, and the ETPU slippers are molded by foaming after steam pressurization and heating, such that the rubber sheet and the ETPU material can be integrally obtained, thus further improving the production efficiency of the ETPU slippers.

In a second aspect, the present application provides a producing method of ETPU slippers, which has the following technical solution.

A producing method of ETPU slippers includes the following steps:
step S1: performing granulation;
step S2: foaming TPU;
step S3: performing secondary foaming molding, specifically including:
S31: moving a movable die module towards a fixed die module for assembly;
S32: injecting ETPU foaming particles into a first die cavity and a second die cavity, and performing steam pressurizing and heating to mold a slipper blank; and
S33: pulling a movable inner support outwards after separation, and removing the slipper blank from the movable inner support;
step S4: performing baking; and
step S5: preforming trimming.

By adopting the above technical solution, with the above technology, after the ETPU foaming particles are foamed in the first die cavity and the second die cavity, the slipper blank can be obtained using single molding; after the molding, the movable die module is separated from the fixed die module, the movable inner support is pulled outwards to facilitate release of the slipper blank, and the slipper blank is then sent into a baking chamber to be baked and then trimmed, such that processing of the ETPU slippers can be rapidly completed, and the mass production of the ETPU slippers is facilitated.

In summary, the present application has at least one of the following beneficial effects.

1. By arranging the movable inner support, in the closed state, the first molding space can be formed between the movable inner support and the inner wall of the first die cavity of the male die, the second molding space can be formed between the movable inner support and the inner wall of the second die cavity of the die frame, and after the ETPU particles are injected into the die cavity subsequently, single foaming molding of the ETPU slippers can be completed with steam pressurization and heating;

2. the movable inner support is slidably arranged in the movement channel, and after the slippers are molded by foaming, the movable die module is separated from the fixed die module to force the movable inner support to move outwards along the movement channel, such that the distance between the movable inner support and the inner wall of the first die cavity can be increased to facilitate the smooth release of the slippers;

3. by arranging the guide seat fixedly connected with the movable inner support, in the closed state, the guide post of the guide seat is inserted into the guide groove in the matched mode, and the hard rubber sleeve is in interference fit with the guide groove, such that in the separation process, the guide seat and the movable inner support can be automatically driven to move away from the inner wall of the first die cavity by a distance using the friction force, which is more favorable for the rapid release of the ETPU slippers after foaming molding.

### BRIEF DESCRIPTION OF THE DRAWINGS

FIG. 1 is a schematic structural diagram of a fixed die module in a first embodiment;

FIG. 2 is a schematic structural diagram of a movable die module in the first embodiment;

FIG. 3 is an enlarged view of portion A in FIG. 2;

FIG. 4 is a schematic structural diagram of a fixed die base in the first embodiment;

FIG. 5 is a sectional view of a movable inner support in a second embodiment, which mainly shows an internal structure of the movable inner support;

FIG. 6 is an enlarged view of portion B in FIG. 5;

FIG. 7 is a schematic diagram of an internal structure of the movable die module in a separation state in the second embodiment; and

FIG. 8 is a schematic diagram of an internal structure of the movable die module in an assembly state in the second embodiment.

### DETAILED DESCRIPTION

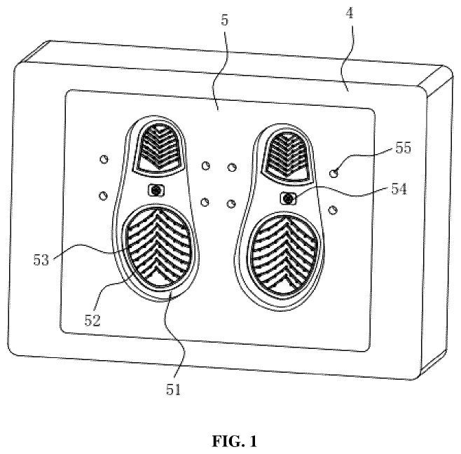

The present application is described in further detail below with reference to FIGS. 1 to 8.

### First Embodiment

An embodiment of the present application discloses a molding die of ETPU slippers.

Referring to FIG. 1, the molding die of ETPU slippers includes a movable die module and a fixed die module, and the movable die module and the fixed die module are directly opposite; the fixed die module includes a fixed die base 4 and a die frame 5, the fixed die base 4 is fixedly embedded in a die device, and the die frame 5 is fixedly embedded in a side surface of the fixed die base 4. A second die cavity 51 is formed in a side surface of the die frame 5 close to the movable die module, and a plurality of sole patterns 52 are arranged on an inner bottom wall of the second die cavity 51.

In the present embodiment, two sole patterns 52 are provided, one sole pattern 52 is located at a front palm portion of the die frame 5, and the other sole pattern 52 is located at a heel portion of the die frame 5. A plurality of raised pillars 53 are provided on a surface of each sole pattern 52, the raised pillars 53 protrude from the surface of the sole pattern 52, and each raised pillar 53 and the corresponding sole pattern 52 are integrally molded. The raised pillars are configured to clamp and position sole rubber sheets, such that the rubber sheets and the ETPU slippers can be integrally molded.

An injection hole 54 is further formed in the inner bottom wall of the second die cavity 51, and the injection hole 54 is located between the two sole patterns 52; the injection hole 54 is configured to be communicated with an external ETPU foaming particle storage tank, and ETPU foaming particles can be injected into the die cavity through a pipeline.

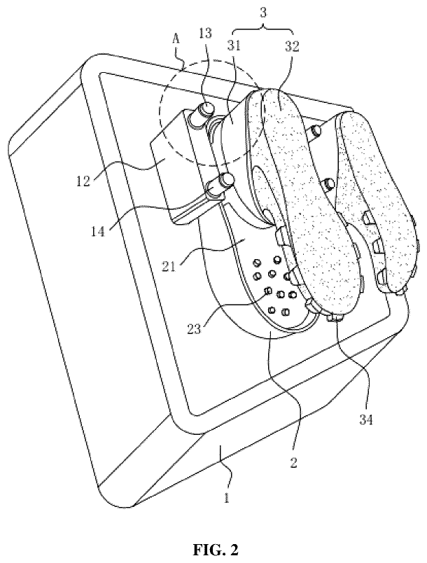

Referring to FIG. 2, the movable die module includes a movable die base 1, a male die 2 and a movable inner support 3, the movable die base 1 is fixed on a mobile device, and the mobile device is driven by a group of linear driving mechanisms, such that the mobile device and the movable die base 1 can move together towards the fixed die module; specific structures of the mobile device and the driving mechanism are conventional design in the art, are not protected key points of the present application, and are not repeated herein.

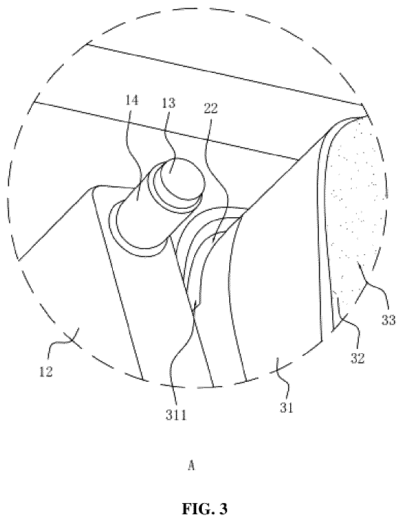

The male die 2 is fixed on the movable die base 1 and protrudes from a side surface of the movable die base 1 close to the fixed die base 4, an outer circumferential edge of the male die 2 is matched with an inner circumferential edge of the second die cavity 51, and when the movable die module and the fixed die module are assembled, the male die 2 can enter the second die cavity 51 in a matched mode. A first die cavity 21 is formed in a side surface of the male die 2 close to the fixed die base 4, and referring to FIG. 3, a movement channel 22 is formed in an inner bottom wall of the first die cavity 21, and the movable inner support 3 is movably mounted in the movement channel 22.

Returning to FIG. 2, the movable inner support 3 includes a movable portion 31 and an inner support portion 32, and the movable portion 31 and the inner support portion 32 are integrally molded; a shape of the inner support portion 32 is matched with a shape of the foot of a person, and a shape of the movable portion 31 is matched with a shape of the movement channel 22. The movable portion 31 is movably inserted in the movement channel 22, and in an assembly state, the movable portion 31 can move inwards to a limit position along the movement channel 22, and at this point, a first molding space can be formed between the inner support portion 32 and an inner wall of the first die cavity 21 of the male die 2, and configured to mold an upper surface of the slipper by foaming; a second molding space can be formed between the inner support portion 32 and an inner wall of the second die cavity 51 of the die frame 5, and configured to mold a sole of the slipper by foaming; it can be known that the first molding space can be communicated with the second molding space, so as to facilitate single forming of the ETPU slippers.

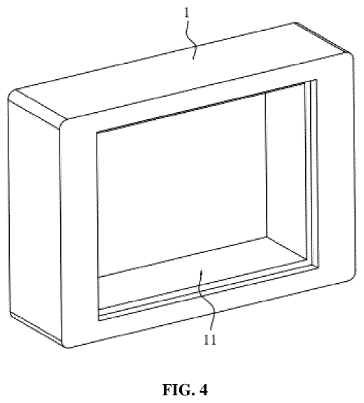

The movable inner support 3 in the present embodiment is of a hollow structure, and a side surface of the movable portion 31 away from the inner support portion 32 is provided in a through opening form; referring to FIG. 4, a steam chamber 11 for conveying steam is formed inside the movable die base 1, and the movement channel 22 is in communication with the steam chamber 11, such that the opening side of the movable portion 31 can extend into the steam chamber 11; a surface of the inner support portion 32 is provided with a plurality of steam micropores 33, each steam micropore 33 extends to an interior of the movable inner support 3, and after pressurization in the steam chamber 11, the steam can pass through an inner side of the movable inner support 3 and each steam micropore 33 and finally enter the inner wall of the die cavity to steam the ETPU foaming particles, such that the ETPU foaming particles are foamed and expanded to form a slipper blank.

It should be noted that a steam chamber 11 can also be formed in the fixed die base 4, and steam micropores 33 communicated with the steam chamber 11 can also be distributed in surfaces of the male die 2 and the die frame 5, such that inner sides and outer sides of the ETPU foamed particles can be synchronously subjected to steam pressurization and heating, which facilitates an improvement of molding quality of the slipper blank.

In addition, returning to FIG. 2, the movable inner support 3 is provided with a plurality of first molding parts 34 and a plurality of third molding parts (not shown), and in the present embodiment, a number of the first molding parts 34 is plural, the first molding parts 34 are arranged at intervals on a side edge of the inner support portion 32, the first molding parts 34 and the inner support portion 32 are integrally molded, and the first molding parts are configured to directly form holes in an edge of an upper when the ETPU foaming particles are foamed.

A number of the third molding parts is also plural, the third molding parts are arranged on a surface of the inner support portion 32 away from the first die cavity 21, and the third molding parts and the inner support portion 32 are integrally molded; the inner bottom wall of the first die cavity 21 is further provided with a plurality of second molding parts 23, a number of the second molding parts 23 is equal to the number of the third molding parts, and in the closed state, the movable inner support 3 moves inwards to the limit position, and the second molding parts 23 can correspondingly abut against the third molding parts respectively to directly form holes in an upper surface when foaming of the ETPU foaming particles is completed.

A guide seat 12 is provided on the side surface of the movable die base 1 close to the fixed die base 4, an embedding groove is formed in the side surface of the movable die base 1 close to the fixed die base 4, and the guide seat 12 is movably inserted in the embedding groove. In the present embodiment, a number of the guide seats 12 is two, and the two guide seats 12 are arranged on two opposite sides of the male die 2 respectively; each guide seat 12 is fixedly connected to the movable portion 31 through a link part, and the link part is located inside the steam chamber 11. In a normal state, i.e., a separation state, the movable inner support 3 is pulled to move outwards to a limit position, and the guide seat 12 can be exposed out of the movable die base 1; in the closed state, the guide seat 12 can finally abut against a side surface of the fixed die base 4 close to the movable die base 1, such that the guide seat 12 completely retracts into the embedding groove.

Referring to FIGS. 1 and 2, a guide post 13 is fixed on a side surface of the guide seat 12 close to the fixed die base 4, a guide groove 55 is formed in the side surface of the die frame 5 close to the movable die base 1, and the guide post 13 can be inserted into the guide groove 55 in a matched mode in the closed state; in addition, an end portion of the guide post 13 has taper, a hard rubber sleeve 14 is sleeved on an outer circumferential side of the guide post 13, the hard rubber sleeve 14 can be in interference fit with an inner wall of the guide groove 55 after inserted into the guide groove 55, and then, during subsequent separation, the guide seat 12 and the movable inner support 3 can be automatically driven outwards by a distance using a friction force, so as to facilitate a release operation of the slipper blank.

In addition, referring to FIG. 3, a structural groove 311 is partially formed in the movable portion 31, and in the present embodiment, the movable die module and the fixed die module are directly opposite to each other along a horizontal direction, and the structural groove 311 is located at an upper edge of the movable portion 31; in the closed state, the structural groove 311 retracts into the steam chamber 11, and in the opened state, after the movable inner support 3 moves away from the first die cavity 21, the structural groove 311 can be located in the movement channel 22, and at this point, a rotation allowance is reserved between the movable portion 31 and the movement channel 22, and the release operation of the slipper blank can be conveniently performed by shifting the movable inner support 3 up and down, thus further improving release convenience.

It should be noted that, in the present embodiment, a movement allowance also exists between the guide seat 12 and the embedding groove, the guide seat 12 constantly abuts against a lower bottom wall of the embedding groove under the action of gravity thereof, and therefore, a gap is reserved between the guide seat 12 and an upper top wall of the embedding groove, such that the guide seat 12 can swing with the movable inner support 3 when the movable inner support swings up and down; during the subsequent assembly, whether the movable inner support 3 is inclined or not can be judged by observing matching between the guide post 13 and the guide groove 55.

In addition, after the movable inner support 3 swings up and down and is inclined, a steam pressure in the steam chamber 11 subsequently acts on the guide seat 12 and the movable inner support 3, such that the movable inner support 3 can be conveniently corrected, so as to smoothly assemble the movable die module and the fixed die module.

### Second Embodiment

An embodiment of the present application discloses a molding die of ETPU slippers.

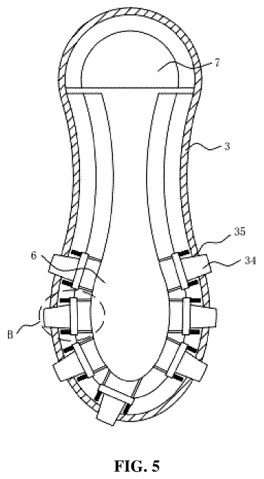

Referring to FIG. 5, components of the molding die of ETPU slippers which are the same as those in the first embodiment are not repeated herein; the present embodiment is different from the first embodiment in that, in the present embodiment, a plurality of movement grooves 35 are formed in a side edge of the movable inner support 3, a number of the movement grooves 35 is equal to the number of the first molding parts 34, the first molding parts 34 are correspondingly and slidably inserted into the movement grooves 35, an elastic mechanism 6 is provided between the first molding parts 34 and the movable inner support 3, and the elastic mechanism 6 is configured to force the first molding parts 34 to naturally move inwards and retract into the movement grooves 35.

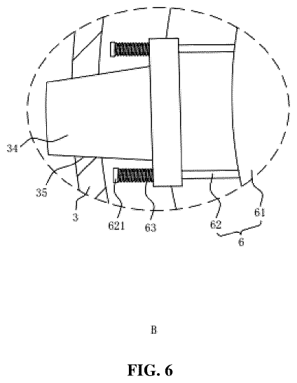

Referring to FIG. 6 in particular, the elastic mechanism 6 includes a base plate 61 and a plurality of insertion posts 62 fixed to an outer edge of the base plate 61, the base plate 61 is matched with the inner support portion 32 in shape and placed inside the movable inner support 3 through the opening of the movable portion 31, the base plate 61 is fixed inside the movable inner support 3 by a fastener, and the fixing position of the base plate 61 and the movable inner support 3 is close to the opening side of the movable inner support 3.

Each first molding part 34 is slidably inserted into two insertion posts 62, and it can be understood that the two insertion posts 62 are oriented in a same direction; the first molding part 34 is provided with an insertion hole, the insertion post 62 is inserted in the insertion hole in a matched mode, an end of the insertion post 62 away from the base plate 61 is provided with an integrally molded disengagement-preventing portion 621, and an outer diameter of the disengagement-preventing portion 621 is greater than that of the insertion post 62 to limit the condition that the first molding part 34 is directly separated from the insertion post 62; a spring 63 is further sleeved on the insertion post, one end of the spring 63 abuts against the disengagement-preventing portion 621, and the other end of the spring abuts against the first molding part 34; the spring 63 can always generate an elastic force acting on the first molding part 34, such that the first molding part 34 is forced to move towards the base plate 61, and thus automatically retracts into the movement groove 35.

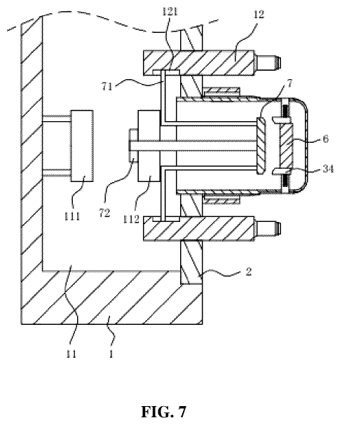

Referring to FIG. 7, a retaining part 7 is further provided on the inner side of the movable inner support 3, the retaining part 7 is fixedly connected with a sliding post 71, and the sliding post 71 is in an L shape; a sliding groove 121 is formed in a side surface of the guide seat 12 close to the movable inner support 3, an extending direction of the sliding groove 121 is the same as a moving direction of the movable inner support 3, and the sliding post 71 can be slidably connected to the sliding groove 121, such that the retaining part 7 can move relative to the movable inner support 3.

A first blocking seat 111 and a second blocking seat 112 are fixedly erected in the steam chamber 11 of the movable die base 1, and the second blocking seat 112 is located on a side of the first blocking seat 111 away from the retaining part 7; the retaining part 7 is fixedly connected with a limiting post 72, the limiting post 72 is also in an L shape, and an end of the limiting post 72 away from the retaining part 7 is partially located between the first blocking seat 111 and the second blocking seat 112. in the opened state, after the retaining part 7 moves outwards, the limiting post 72 can abut against the first blocking seat 111 and is located at an outward movement limiting position, and at this point, the movable inner support 3 is continuously pulled outwards, and the retaining part 7 can be staggered with each first molding part 34, such that the first molding part 34 can automatically retract into the movement groove 35 under the elastic force of the spring 63.

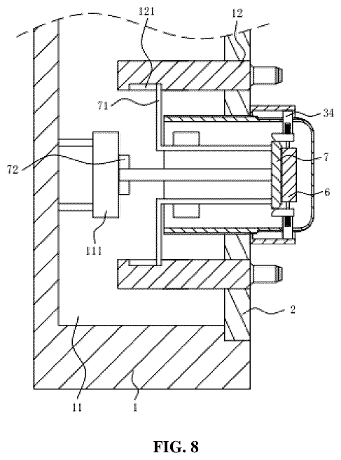

With additional reference to FIG. 8, when the movable die module and the fixed die module are assembled, the movable inner support 3 moves inwards towards the first die cavity 21, and a side end surface of the sliding groove 121 close to the fixed die base 4 can abut against the sliding post 71; after the assembly is completed, the limiting post 72 can abut against the second blocking seat 112, and the retaining part 7 can be kept fixed through limiting of the side end surface of the sliding groove 121 close to the fixed die base 4 and limiting of the second blocking seat 112; at this point, the retaining part 7 can abut against each first molding part 34, and thus force each first molding part 34 to move outwards to the limit position and block the movement groove 35, so as to facilitate smooth molding of the hole in the edge of the slipper.

### Third Embodiment

An embodiment of the present application further discloses a producing method of ETPU slippers.

The producing method of ETPU slippers is applied to the ETPU slipper die according to the first embodiment or the second embodiment and used for molding the whole slipper blank at a time.

The producing method of ETPU slippers includes the following steps:
step S1: performing granulation; adding auxiliary agents and color powder in certain proportions into a TPU material, uniformly stirring the mixture, pouring the mixture into a double-screw granulator for processing banburying, and cutting the banburied material by a particle cutter into particles with certain sizes for later use;
step S2: foaming TPU; quantitatively pouring the cut particles into a drying device for drying for later use, and then introducing the TPU particles into a high-pressure foaming kettle for foaming to form popcorn, also called ETPU.
step S3: performing secondary foaming molding, specifically including:
S31: moving the movable die module towards the fixed die module for assembly, and before the assembly, pressurizing the interior of the steam chamber 11 to introduce the steam, and adjusting the movable inner support 3 to a horizontal orientation by the steam pressure;
S32: after the assembly, injecting the ETPU foaming particles into the first die cavity 21 and the second die cavity 51 through the injection hole 54, and performing steam pressurizing and heating again to mold the slipper blank; and
S33: separating the movable die module from the fixed die module, and automatically driving the movable inner support 3 by a distance after the separation; pulling the movable inner support 3 outwards, and then removing the slipper blank from the movable inner support 3;
step S4: performing baking; baking the slipper blank in a baking room at 50+/−5° C. for 3-4 hours, and pushing out the slipper blank after the slipper blank is dried; and
step S5: performing trimming; trimming burrs at a separation line of the slipper blank.

The above embodiments are preferred embodiments of the present application, and the protection scope of the present application is not limited thereby, and therefore, equivalent changes made according to the structure, shape and principle of the present application shall be covered by the protection scope of the present application.

### LISTING OF REFERENCE SIGNS

1. Movable Die Base
11. Steam Chamber
111. First Blocking Seat
112. Second Blocking Seat
12. Guide Seat
121. Sliding Groove
13. Guide Post
14. Hard Rubber Sleeve
2. Male Die
21. First Die Cavity
22. Movement Channel
23. Second Molding Part
3. Movable Inner Support
31. Movable Portion
311. Structural Groove
32. Inner Support Portion
33. Steam Micropore
34. First Molding Part
35. Movement Groove
4. Fixed Die Base
5. Die Frame
51. Second Die Cavity
52. Sole Pattern
53. Raised Pillar
54. Injection Hole
55. Guide Groove
6. Elastic Mechanism
61. Base Plate
62. Insertion Post
621. Disengagement-Preventing Portion
63. Spring
7. Retaining Part
71. Sliding Post
72. Limiting Post

What is claimed is:

1. A molding die of expanded thermoplastic polyurethane (ETPU) slippers, comprising a movable die module and a fixed die module, wherein the movable die module comprises a movable die base, a male die fixed on the movable die base and a movable inner support movably arranged in the male die; a first die cavity is formed in a side surface of the male die, a movement channel is formed in an inner bottom wall of the first die cavity, and the movable inner support is movably mounted in the movement channel;
the fixed die module comprises a fixed die base and a die frame fixed on the fixed die base, and a second die cavity matched with the male die in shape is formed in a side surface of the die frame; in a closed state, the movable inner support is moved towards an inner side of the male die to a limit position, and a first molding space for molding an upper surface is formed between the movable inner support and the male die; the male die is fit into the second die cavity, and a second molding space for molding a sole is formed between the movable inner support and the die frame.

2. The molding die according to claim 1, wherein the movable inner support comprises a movable portion and an inner support portion which are connected with each other, and a shape of the inner support portion is matched with a shape of a foot; a shape of the movable portion is matched with a shape of the movement channel, the movable portion is movably inserted into the movement channel, and in an opened state, a rotation allowance is reserved between the movable portion and the movement channel after the movable inner support is moved away from the first die cavity.

3. The molding die according to claim 2, wherein a guide seat is movably inserted in a side surface of the movable die base close to the fixed die base, the guide seat is constantly exposed out of the movable die base, and the guide seat is fixedly connected with the movable portion; a guide post is fixed on a side surface of the guide seat close to the fixed die base, and a rubber sleeve is sleeved on an outer circumferential side of the guide post; the die frame is provided with a guide groove, and in the closed state, the guide post is inserted into the guide groove, and the rubber sleeve is in interference fit with the guide groove.

4. The molding die according to claim 3, wherein a steam chamber for conveying steam is formed in the movable die base, the movement channel penetrates through the male die and is in communication with the steam chamber, and the movable inner support and the die frame are configured to be kept directly opposite by a steam pressure in the opened state; the movable inner support is of a hollow structure, a side surface of the movable portion away from the inner support portion is in communication with the steam chamber, and a plurality of steam micropores are distributed in a surface of the inner support portion.

5. The molding die according to claim 3, wherein a plurality of first molding parts are arranged at a side edge of the movable inner support and configured to form holes at an edge of an upper; a plurality of second molding parts are arranged at the inner bottom wall of the first die cavity, a plurality of third molding parts are arranged on a side surface of the movable inner support, and in the closed state, the second molding parts correspondingly abut against the third molding parts to form the holes in the upper surface.

6. The molding die according to claim 5, wherein the movable inner support is a hollow structure, and a side surface of the movable portion away from the inner support portion is in communication with a steam chamber for conveying steam that is formed in the movable die base; a plurality of movement grooves are formed in the side edge of the movable inner support, the first molding parts are correspondingly and slidably inserted into the movement grooves, and an elastic mechanism is arranged between the first molding parts and the movable inner support;
a retaining part is further provided on an inner side of the movable inner support, the retaining part is slidably connected to the guide seat, and in the opened state, the retaining part and the first molding parts are staggered, and the elastic mechanism forces the first molding parts to move toward the inner side of the movable inner support; in the closed state, the retaining part is configured to abut against each of the first molding parts to force the first molding parts to move outwards to a limit position.

7. The molding die according to claim 6, wherein a sliding groove is formed in a side surface of the guide seat, an extending direction of the sliding groove is the same as a moving direction of the movable inner support, the retaining part is fixedly connected with a sliding post, and the sliding post is slidably connected to the sliding groove; a first blocking seat and a second blocking seat are fixedly erected on an inner side of the movable die base, and the second blocking seat is located on a side of the first blocking seat away from the retaining part; the retaining part is fixedly connected with a limiting post, the limiting post is partially located between the first blocking seat and the second blocking seat, and in the opened state, the limiting post abuts against the first blocking seat, and the retaining part is staggered with each of the first molding parts; in the closed state, the limiting post abuts against the second blocking seat and the sliding post abuts against a side end surface of the sliding groove close to the fixed die base.

8. The molding die according to claim 6, wherein the elastic mechanism comprises a base plate fixedly erected on an inner side surface of the movable inner support and a plurality of insertion posts fixed on an outer edge of the base plate, each of the first molding parts is provided with an insertion hole, and the insertion posts is inserted into the insertion holes; ends of the insertion posts away from the base plate are provided with a disengagement-preventing portion, a spring is provided between the disengagement-preventing portion and the first molding parts, and the spring is configured to force the first molding parts to move toward the base plate.

9. The molding die according to claim 1, wherein a plurality of sole patterns are arranged on an inner bottom wall of the second die cavity, a surface of the sole patterns is provided with a plurality of raised pillars, and the raised pillars are configured to position sole rubber sheets.

10. A method for producing expanded thermoplastic polyurethane (ETPU) slippers using the molding die according to claim 1, comprising the following steps:
step S1: performing granulation;
step S2: foaming thermoplastic polyurethane (TPU);
step S3: performing secondary foaming molding, specifically comprising:
S31: moving the movable die module towards the fixed die module;
S32: injecting ETPU foaming particles into the first die cavity and the second die cavity, and performing steam pressurizing and heating to mold a slipper blank; and
S33: pulling the movable inner support outwards after separation, and removing the slipper blank from the movable inner support;
step S4: performing baking; and
step S5: preforming trimming.
